(19) United States
(12) Patent Application Publication
(10) Pub. No.: US 2013/0038150 A1
(43) Pub. Date: Feb. 14, 2013

(54) ELECTRIC MACHINE MODULE COOLING SYSTEM AND METHOD

(71) Applicants: Bradley D. Chamberlin, Pendleton, IN (US); James J. Ramey, Fortville, IN (US); Alex S. Crevision, Muncie, IN (US)

(72) Inventors: Bradley D. Chamberlin, Pendleton, IN (US); James J. Ramey, Fortville, IN (US); Alex S. Crevision, Muncie, IN (US)

(21) Appl. No.: 13/207,301

(22) Filed: Aug. 10, 2011

(51) Int. Cl. H02K 5/20; H02K 15/00

(52) U.S. Cl. 310/59; 29/596

(57) ABSTRACT

Embodiments of the invention provide an electric machine module. The module can include a housing, which can define a machine cavity. The housing can include a first axial end, a coolant jacket, and a plurality of coolant passages. In some embodiments, the coolant passages fluidly connect to the coolant jacket via at least one coolant aperture disposed through the housing. The housing can include a first guide positioned adjacent to the first axial end and extending into the machine cavity. The first guide is positioned so that a portion of the first guide is substantially adjacent to a portion of the rotor assembly. In some embodiments, the first guide is configured and arranged to guide a coolant toward the rotor assembly.

### BACKGROUND

Electric machines, often contained within a machine cavity of a housing, generally include a stator and a rotor. For some electric machines, the stator can be secured to the housing using different coupling techniques to generally secure the electric machine within the housing. During operation of electric machines, heat energy can by generated by both the stator and the rotor, as well as other components of the electric machine. For some electric machines, the increase in heat energy can, at least partially, impact electric machine operations.

### SUMMARY

Some embodiments of the invention provide an electric machine module. The module can include a housing, which can define a machine cavity. In some embodiments, the housing can include a coolant jacket, a first axial end, and a second axial end. In some embodiments, the housing can include a plurality of coolant passages at least partially defined by the housing and fluidly connected to the coolant jacket via at least one coolant aperture disposed through the housing. In some embodiments, the housing can comprise a first guide positioned substantially adjacent to the first axial end so that the first guide can extend into the machine cavity. In some embodiments, an electric machine can be positioned within the machine cavity. In some embodiments, the electric machine can include a rotor assembly. In some embodiments, the first guide can be positioned so that it is substantially adjacent to a portion of the rotor assembly. Moreover, in some embodiments, the first guide can be configured and arranged to guide a portion of a coolant toward a portion of the rotor assembly.

Some embodiments of the invention provide an electric machine module including a housing. In some embodiments, the housing can at least partially define a machine cavity and can include a first and a second axial end. In some embodiments, the housing can comprise a plurality of coolant passages, at least a portion of which can be positioned substantially adjacent to the first axial end of the housing and another portion of which can be positioned substantially adjacent to the second axial end of the housing. In some embodiments, a sensor assembly, including a second guide, can be coupled to a portion of the housing substantially adjacent to the second axial end. In some embodiments, at least one of the first guide and the second guide can include at least one guide aperture and at least one guide passage.

### DESCRIPTION OF THE DRAWINGS

FIG. 1 is a cross-sectional view of an electric machine module according to one embodiment of the invention.

FIG. 2 is a partial cross-sectional view of a portion of an electric machine module according to one embodiment of the invention

FIG. 3 is partial cross-sectional view of a portion of the electric machine module of FIG. 2.

FIG. 4 is an isometric view of an end cap according to one embodiment of the invention.

FIG. 5 is an isometric view of an end turn member according to one embodiment of the invention.

FIG. 6 is a partial cross-sectional view of a portion of an electric machine module according to one embodiment of the invention.

FIG. 7 is a partial cross-section view of an end turn member according to one embodiment of the invention.

FIG. 8 is an isometric view of a stator assembly according to one embodiment of the invention.

FIG. 9 is partial cross-sectional view of a portion of the electric machine module of FIG. 2.

FIG. 10A is an isometric view of a portion of an electric machine module according to one embodiment of the invention.

FIG. 10B is a rear isometric view of a sensor assembly according to embodiment of the invention.

FIG. 10C is an isometric view of a sensor cover of the sensor assembly of FIG. 10B.

FIG. 11 is an isometric view of a first guide according to one embodiment of the invention.

FIG. 12 is an isometric view of a first guide according to one embodiment of the invention.

FIG. 13 is a cross-sectional view of a portion of an electric machine module according to one embodiment of the invention.

FIG. 14 is a cross-sectional view of a portion of an electric machine module according to one embodiment of the invention.

FIG. 15 is a cross-sectional view of a portion of an electric machine module according to one embodiment of the invention.

FIG. 16 is a cross-sectional view of a portion of an electric machine module according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

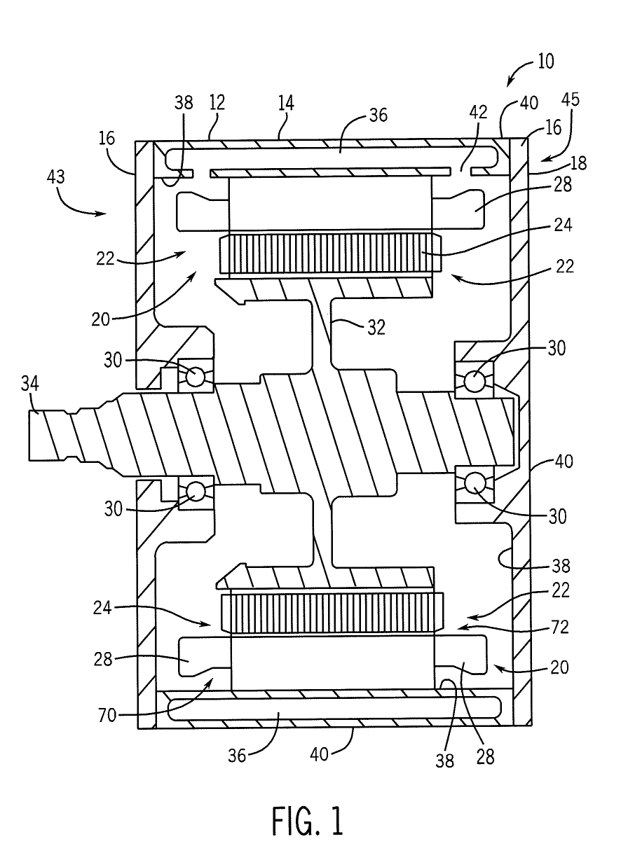

FIG. 1 illustrates an electric machine module 10 according to one embodiment of the invention. The module 10 can include a housing 12 comprising a sleeve member 14, a first end cap 16, and a second end cap 18. An electric machine 20 can be housed within a machine cavity 22 at least partially defined by the sleeve member 14 and the end caps 16, 18. For example, the sleeve member 14 and the end caps 16, 18 can be coupled via conventional fasteners (not shown), or another suitable coupling method, to enclose at least a portion of the electric machine 20 within the machine cavity 22. In some embodiments the housing 12 can comprise a substantially cylindrical canister and a single end cap (not shown). Further, in some embodiments, the module housing 12, including the sleeve member 14 and the end caps 16, 18, can comprise materials that can generally include thermally conductive properties, such as, but not limited to aluminum or other metals and materials capable of generally withstanding operating temperatures of the electric machine. In some embodiments, the housing 12 can be fabricated using different methods including casting, molding, extruding, and other similar manufacturing methods.

The electric machine 20 can include a rotor assembly 24, a stator assembly 26, including stator end turns 28, and bearings 30, and can be disposed about a shaft 34. As shown in FIG. 1, the stator assembly 26 can substantially circumscribe at least a portion of the rotor assembly 24. In some embodiments, the rotor assembly 24 can also include a rotor hub 32 or can have a “hub-less” design (not shown).

In some embodiments, the electric machine 20 can be operatively coupled to the module housing 12. For example, the electric machine 20 can be fit within the housing 12. In some embodiments, the electric machine 20 can be fit within the housing 12 using an interference fit, a shrink fit, other similar friction-based fit that can at least partially operatively couple the machine 20 and the housing 12. For example, in some embodiments, the stator assembly 26 can be shrunk fit into the module housing 12. Further, in some embodiments, the fit can at least partially secure the stator assembly 26, and as a result, the electric machine 20, in both axial and circumferential directions. In some embodiments, during operation of the electric machine 20 the fit between the stator assembly 26 and the module housing 12 can at least partially serve to transfer torque from the stator assembly 26 to the module housing 12. In some embodiments, the fit can result in a generally greater amount of torque retained by the module 10.

The electric machine 20 can be, without limitation, an electric motor, such as a hybrid electric motor, an electric generator, or a vehicle alternator. In one embodiment, the electric machine 20 can be a High Voltage Hairpin (HVH) electric motor or an interior permanent magnet electric motor for hybrid vehicle applications.

Components of the electric machine 20 such as, but not limited to, the rotor assembly 24, the stator assembly 26, and the stator end turns 28 can generate heat during operation of the electric machine 20. These components can be cooled to increase the performance and the lifespan of the electric machine 20.

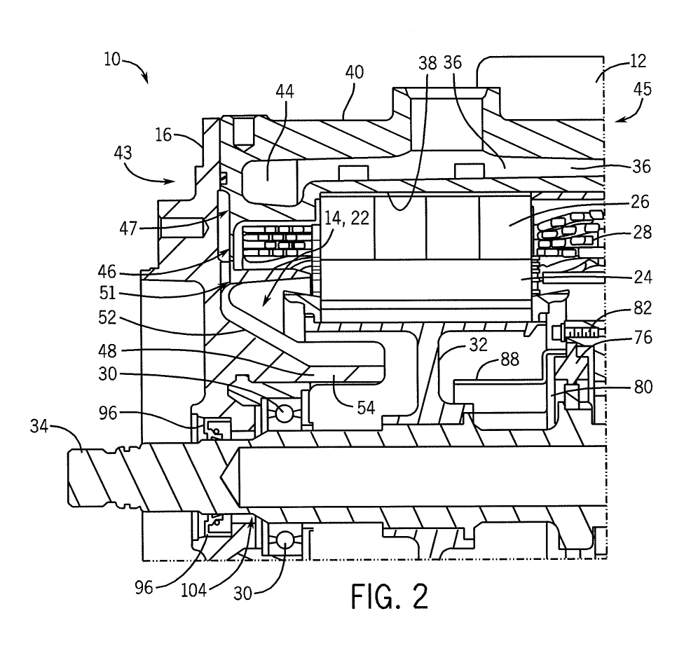

As shown in FIGS. 1 and 2, in some embodiments, the housing 12 can comprise a coolant jacket 36. In some embodiments, the housing 12 can include an inner wall 38 and an outer wall 40 and the coolant jacket 36 can be positioned substantially between at least a portion the walls 38, 40. For example, in some embodiments, the machine cavity 22 can be at least partially defined by the inner wall 38 (e.g., each of the elements of the housing 12 can comprise a portion of the inner wall 38). In some embodiments, the coolant jacket 36 can substantially circumscribe at least a portion of the electric machine 20. More specifically, in some embodiments, the coolant jacket 36 can substantially circumscribe at least a portion of an outer perimeter of the stator assembly 26, including the stator end turns 28.

Further, in some embodiments, the coolant jacket 36 can contain a coolant that can comprise transmission fluid, ethylene glycol, an ethylene glycol/water mixture, water, oil, motor oil, a gas, a mist, or a similar substance. The coolant jacket 36 can be in fluid communication with a coolant source (not shown) which can pressurize the coolant prior to or as it is being dispersed into the coolant jacket 36, so that the pressurized coolant can circulate through the coolant jacket 36.

Also, in some embodiments, the inner wall 38 can include coolant apertures 42 so that the coolant jacket 36 can be in fluid communication with the machine cavity 22. In some embodiments, the coolant apertures 42 can be positioned substantially adjacent to the stator end turns 28. For example, in some embodiments, as the pressurized coolant circulates through the coolant jacket 36, at least a portion of the coolant can exit the coolant jacket 36 through the coolant apertures 42 and enter the machine cavity 22. Also, in some embodiments, the coolant can contact the stator end turns 28, which can lead to at least partial cooling. After exiting the coolant apertures 42, at least a portion of the coolant can flow through the machine cavity 22 and can contact various module 10 elements, which, in some embodiments, can lead to at least partial cooling of the module 10.

According to some embodiments of the invention, the coolant jacket 36 can include multiple configurations. In some embodiments, at least a portion of the coolant jacket 36 can extend through the sleeve member 14 a distance substantially similar to an axial length of the stator assembly 26. For example, in some embodiments, an axial length of a portion of the coolant jacket 36 can extend at least the same distance as the axial length of the stator assembly 26, including the stator end turns 28. In some embodiments, portions of the coolant jacket 36 can extend greater and lesser axial distances, as desired by manufacturers and/or end users for cooling.

In some embodiments, a portion of the coolant jacket 36 also can comprise at least one radially inward extension 44. For example, as shown in FIG. 2, in some embodiments, a region of the inner wall 38 can be substantially radially recessed so that the radially inward extension 44 of the coolant jacket 36 can be substantially adjacent to at least one of the stator end turns 28. In some embodiments, radially inward extensions 44 can be positioned adjacent to one of, both of, or neither of the stator end turns 28. Further, in some embodiments, the coolant jacket 36 can comprise radially inward extensions 44 substantially continuously around at least a portion of an outer diameter of at least one of the stator end turns 28 (i.e., one continuous radially inward extension around a portion of at least one of the stator end turns 28). In other embodiments, the coolant jacket 36 can comprise substantially discrete radially inward extensions 44 positioned around at least a portion of an outer diameter 27 of at least one set of the stator end turns 28. In some embodiments, the housing 12 can comprise at least two radially inward extensions 44. For example, in some embodiments, the housing 12 can comprise two halves coupled together in a substantially axially central location so that each half of the housing 12 can comprise a radially inward extension 44 and the electric machine 20 can be positioned substantially between the two halves.

In some embodiments, the stator end turns 28 can comprise a generally lesser outer diameter compared to the stator assembly 26, and, as a result, a greater distance can exist between the stator end turns 28 and the cooling jacket 36. In some embodiments, the radially inward extensions 44 of the coolant jacket 36 can enhance module 10 cooling because some of the coolant can circulate relatively closer to the stator end turns 28, compared to embodiments substantially lacking the radially inward extension 44. As a result, in some embodiments, a distance between the coolant and an area rejecting heat energy (i.e., the stator end turns) can be generally minimized, which can lead to generally increased heat energy transfer.

In some embodiments, the module 10 can comprise at least two axial ends 43, 45. In some embodiments, the housing 12, regardless of the configuration, can comprise a first axial end 43 and a second axial end 45. In some embodiments, the axial ends 43, 45 can be substantially interchangeable, and in other embodiments, the axial ends can comprise different elements so that the axial ends 43, 45 are not substantially interchangeable. Additionally, although the first axial end 43 and the second axial end 45 are consistently referenced and depicted, in some embodiments, elements recited as positioned at the first axial end 43 can also be positioned at the second axial end 45, and vice versa.

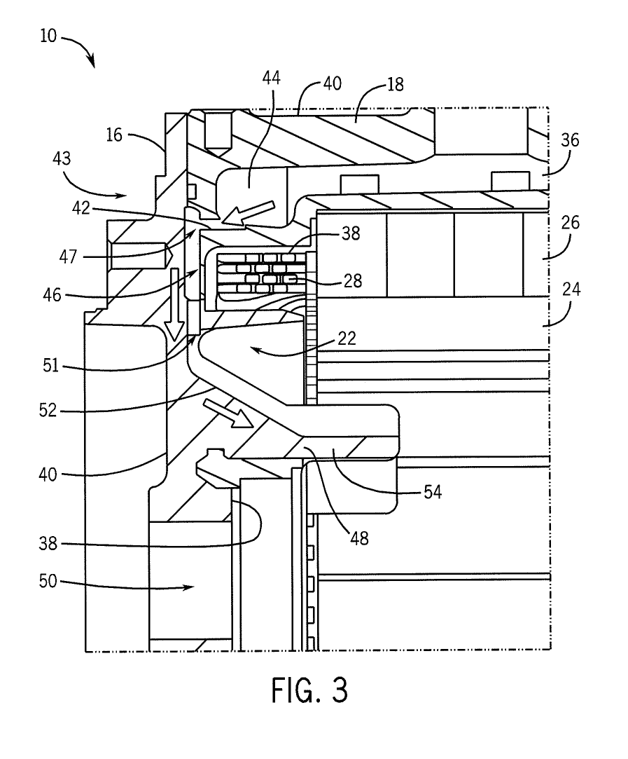

In some embodiments, the module 10 can comprise at least one coolant passage 46 positioned substantially adjacent to the first axial end 43. As shown in FIGS. 2-4, in some embodiments, the coolant passage 46 can be at least partially defined between portions of the housing 12. For example, in some embodiments, the sleeve member 14 and/or at least one of the end caps 16, 18 (or an end cap and the canister) can comprise a recess 47 so that when coupled together, the recesses 47 can form the coolant passage 46, as shown in FIG. 3. In some embodiments, the coolant passage 46 can extend in at least a generally radial direction and can be in fluid communication with the machine cavity 22. Additionally, in some embodiments, the module 10 can comprise a plurality of coolant passages 46. For example, in some embodiments, the coolant passages 46 can be at least partially circumferentially arranged.

In some embodiments, the coolant apertures 42 can fluidly connect the coolant jacket 36 to at least a portion of the coolant passages 46. In some embodiments, at least a portion of some of the coolant passages 46 can be substantially adjacent to a portion of the coolant jacket 36. For example, in some embodiments, at least one of the coolant passages 46 can be substantially axially adjacent to the radially inward extensions 44. Accordingly, in some embodiments, the inner wall 38 can comprise at least one coolant aperture 42 that is configured and arranged to fluidly connect the coolant jacket 36 and coolant passage 46. For example, in some embodiments, the coolant aperture 42 can be disposed through a portion of the inner wall 38 in a generally axial direction to fluidly connect the two elements. As a result, at least a portion of the coolant can flow through the aperture 42 and enter at least some of the coolant passages 46. Additionally, in some embodiments, the coolant aperture 42 need not extend in a generally axial direction and can extend other directions to fluidly connect the coolant jacket 36 and the coolant passage 46 (e.g., the aperture 42 can be substantially slanted so that it extends in both an axial and a radial direction). Moreover, in some embodiments, the coolant passages 46 can comprise other structures and/or configurations that can guide at least a portion of the coolant in a generally radial and/or axial direction from at least one of the coolant apertures 42.

In some embodiments, at least one of the end caps 16, 18 (or the canister and its end cap) can comprise a first guide 48. In some embodiments, each of the end caps 16, 18 (or the canister and its end cap) can comprise a generally radially central shaft aperture 50. In some embodiments, at least a portion of the shaft 34 can axially extend through the shaft apertures 50 and can be operatively coupled to other structures (not shown). In some embodiments, the first guide 48 can be positioned substantially radially adjacent to at least a portion of an outer perimeter of the shaft aperture 50 of at least one of the end caps 16, 18. For example, as shown in FIGS. 2-4, the first guide 48 can be substantially radially adjacent to a generally upper portion of the outer perimeter of the shaft aperture 50, although, in other embodiments, the first guide 48 can substantially circumscribe the outer perimeter of the shaft aperture 50 and/or be substantially radially adjacent to a generally lower portion of the outer perimeter of the shaft aperture 50. In some embodiments, the first guide 48 can be positioned substantially adjacent to the first axial end 43, although in other embodiments, the first guide 48 can be positioned substantially adjacent to the second axial end 45 or substantially adjacent to both axial ends 43, 45.

In some embodiments, the first guide 48 can be coupled to at least one of the end caps 16, 18. In some embodiments, the first guide 48 can be coupled to at least one of the end caps 16, 18 via welding, brazing, conventional fasteners, adhesives, or other coupling methods. In some embodiments, the first guide 48 can be substantially integral with at least one of the end caps 16, 18. For example, in some embodiments, the end caps 16, 18 can be cast, molded, machined, etc. so that the first guide 48 can be formed as portion of at least one of the end caps 16, 18.

In some embodiments, the first guide 48 can axially extend into the machine cavity 22. In some embodiments, the first guide 48 can be positioned with respect to at least one of the end caps 16, 18 so that a portion of the first guide 48 extends into the machine cavity 22. As a result, in some embodiments, at least a portion of the first guide 48 is substantially adjacent to at least a portion of the rotor assembly 24, as shown in FIGS. 2 and 3. For example, as shown in FIG. 2, in some embodiments, at least a portion of the first guide 48 can extend into the machine cavity 22 so that the first guide 48 is substantially radially inwardly adjacent to a portion of the rotor assembly 24 (e.g., the rotor hub 32).

In some embodiments, the first guide 48 can be configured and arranged to guide at least a portion of the coolant from at least one of the coolant passages 46 into the machine cavity 22. In some embodiments, the first guide 48 can be substantially radially adjacent to an outlet 51 of at least a portion of the coolant passages 46. In some embodiments, gravity and other forces can cause at least a portion of the coolant that enters the coolant passages 46 to flow radially inward and exit the passages 46 via the outlets 51 and flow over the first guide 48. As a result, in some embodiments, the first guide 48 can urge, direct, and/or guide at least a portion of the coolant toward the rotor assembly 24, as reflected by the arrows in FIG. 3. Accordingly, in some embodiments, at least a portion of the coolant can contact the rotor assembly 24 (e.g. the rotor hub 32 and other rotor assembly 24 elements) to receive at least a portion of the heat energy produced, which can lead to module 10 cooling. Moreover, in some embodiments, due to the movement of the rotor assembly 24, at least a portion of the coolant can be slung in a generally radially outward direction. As a result, in some embodiments, at least a portion of the radially slung coolant can contact an inner diameter 72 of the stator end turns 28 and other portions of the stator assembly 24 to cool at least those elements.

As shown in FIGS. 2 and 3, in some embodiments, the first guide 48 can comprise multiple regions. For example, in some embodiments, the first guide 48 can include at least one angled region 52 and at least one substantially linear region 54. As shown in FIGS. 2-4, in some embodiments, the angled region 52 can be substantially adjacent to at least some of the outlets 51 so that as at least a portion of the coolant exits the coolant passages 46, the angled region 52 can be configured and arranged to receive the coolant and guide the coolant generally axially inward. Additionally, in some embodiments, the angled region 52 can serve to reduce coolant splashing as the coolant flows through the outlets 51. Then, in some embodiments, at least a portion of the coolant can flow over the linear region 54 before flowing off of the first guide 48 and entering the machine cavity 22 and contacting the rotor assembly 24. Additionally, in some embodiments, although the linear region 54 is depicted as linear, in some embodiments, the linear region 54 can be at least partially angled, bent, arcuate, or otherwise substantially non-linear to guide coolant to a location desired by the manufacturer and/or end user. In some embodiments, the coolant can be at least partially guided from at least some of the outlets 51 by contacting and flowing along the inner wall 38 of the housing 12 in a downward direction until contacting the first guide 48.

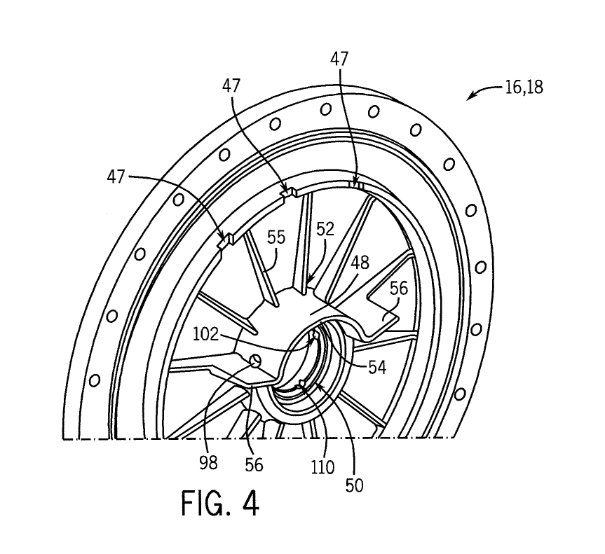

For example, as shown in FIG. 4, in some embodiments, the angled region 52 can comprise at least rib 55. In some embodiments, the rib 55 can be an integral or non-integral portion of at least one of the end caps 16, 18 (or the canister and end cap) that can radially extend from the first guide 48 toward at least one of the recesses 47. In some embodiments, in addition to guiding coolant radially inward, the ribs 55 can at least partially provide structural support for the housing 12.

Referring to FIG. 4, in some embodiments, the first guide 48 can comprise at least one baffle 56. In some embodiments, the first guide 48 can comprise two baffles 56. For example, as shown in FIG. 4, in some embodiments, the first guide 48 can comprise the baffles 56 to at least partially enhance retention of coolant by the first guide 48. In some embodiments, the baffles 56 can be positioned at lateral edges of the first guide 48 so that as coolant contacts the first guide 48 and, at least a portion of the coolant splashes, the baffles 56 can function to at least partially retain a portion of the coolant.

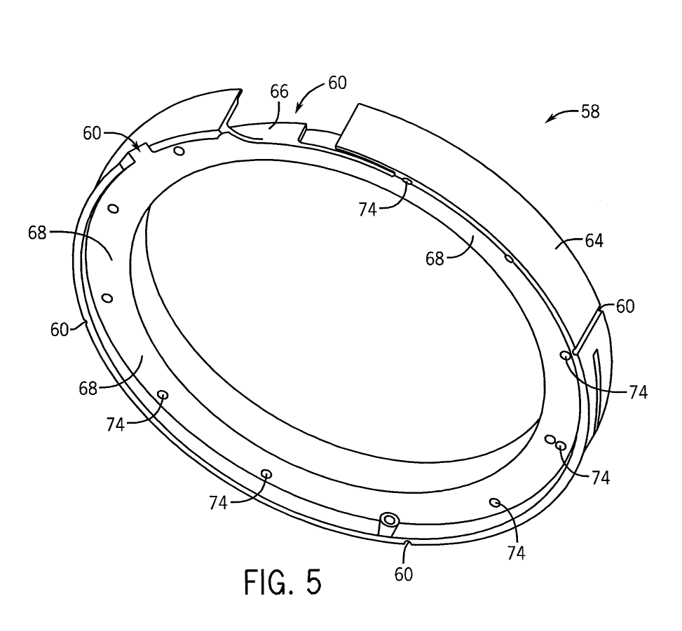

In some embodiments, an end turn member 58 can at least partially enhance module 10 operations. In some embodiments, the end turn member 58 can be substantially annular or ring shaped. In other embodiments, the end turn member 58 can comprise other shapes such as square, rectangular, regular and/or irregular polygonal, and other similar shapes. In some embodiments, the end turn member 58 can comprise a shape that is substantially similar to the general shape of the stator assembly 26, including the stator end turns 28. Moreover, in some embodiments, as shown in FIG. 5, the end turn member 58 can comprise a single structure, however, in other embodiments, the end turn member 58 can comprise multiple subunits coupled together. Further, in some embodiments, the end turn member 58 can comprise materials that can generally include thermally conductive properties, such as, but not limited to aluminum or other metals and materials capable of generally withstanding operating temperatures of the electric machine. In some embodiments, the end turn member 58 can be fabricated using different methods including casting, molding, extruding, and other similar manufacturing methods.

In some embodiments, at least a portion of the inner wall 38 of the housing 12 can comprise the end turn member 58. In some embodiments, the end turn member 58 can be coupled the inner wall 38 of one of the end caps 16, 18 and/or the sleeve member 14. For example, in some embodiments, the end turn member 58 can be press-fit, interference fit, welded, brazed, or otherwise coupled to the inner wall 38 using coupling methods such as, but not limited to conventional fasteners, adhesives, etc. Moreover, in some embodiments, the end turn member 58 can be positioned substantially adjacent to the second axial end 45 of the housing 12.

In some embodiments, the end turn member 58 can comprise at least one feature 60 configured and arranged to at least partially enhance the interaction of the end turn member 58 and the housing 12. For example, in some embodiments, as shown in FIG. 5, the features 60 can comprise apertures, recesses, grooves, flanges, extensions, and any other similar structures. In some embodiments, the features 60 can comprise a combination of configurations positioned around portions of a circumference of the end turn member 58. Moreover, in some embodiments, the features 60 can comprise multiple orientations such as radial, axial, circumferential, or any combination thereof. In some embodiments, regardless of the structure of the features 60, the inner wall 38 of the housing 12 can comprise corresponding features (not shown) configured and arranged to engage the features 60 (e.g., the features 60 can receive a portion of the features of the housing 12 and/or vice versa) of the end turn member 58 to aid in coupling together at least these two elements. Additionally, in some embodiments, the features 60 can substantially function as torque retention elements to help retain torque produced by the electric machine 20 during operations. Furthermore, the features 60 can also function as alignment elements to aid in guiding and/or aligning the end turn member 58 during coupling to the housing 12.

In some embodiments of the invention, the end turn member 58 can be substantially integral with the housing 12. In some embodiments, the housing 12 can be fabricated so that the end turn member 58 extends from the inner wall 38 of the housing 12. For example, in some embodiments, the end turn member 58 can be fabricated (e.g., casting, molding, extruding, etc.) as a portion of the housing 12 so that the elements are formed at substantially the same time and are substantially one element. As an additional example, in some embodiments, the end turn member 58 can be substantially integral with at least one of the end caps 16, 18 and/or the sleeve member 14 so that upon coupling together the end caps 16, 18 and the sleeve member 14, as previously mentioned, the end turn member 58 can be positioned substantially adjacent to the stator assembly 26. Although future references may suggest a non-integral end turn member 58, those references are in no way intended to excluded embodiments comprising a substantially integral end turn member 58 and elements of a substantially integral end turn member 58.

In some embodiments, the end turn member 58 can function to enhance cooling. For example, as previously mentioned, in some embodiments, the coolant jacket 36 can comprise at least one radially inward extension 44. However, installing the stator assembly 26 within the sleeve member 14 can be complicated because of the relative dimensions of the stator assembly 26 and the stator end turns 28. For example, in some embodiments, it can be difficult to position the stator assembly 26 with two radially inward extensions 44 over both axial sides of the stator assembly 26 because the outer diameter of the end turns 28 is less than that of the stator assembly 26. As a result, in some embodiments, the module 10 can comprise a radially inward extension 44 adjacent to one axial end of the stator assembly 26 and the end member 58 substantially adjacent to another axial end of the stator assembly 26. Accordingly, in some embodiments, the end turn member 58 can aid in cooling at least a portion of the stator assembly 26.

In some embodiments, the end turn member 58 can be configured and arranged to direct a portion of the coolant. In some embodiments, the end turn member 58 can comprise at least one first member aperture 62 that can be configured and arranged to substantially align with at least one of the coolant apertures 42 upon positioning of the end turn member 58 adjacent to the electric machine 20. Moreover, in some embodiments, the first member apertures 62 can comprise a substantially radial orientation. For example, in some embodiments, the end turn member 58 can comprise substantially the same number of first member apertures 62 as coolant apertures 42 so that when the end turn member 58 is positioned within the machine cavity 22, at least a portion of the coolant exiting the coolant apertures 42 can also flow through the first member apertures 62. Although, in some embodiments, the end turn member 58 can comprise a different number of first member apertures 62 relative to coolant apertures 42.

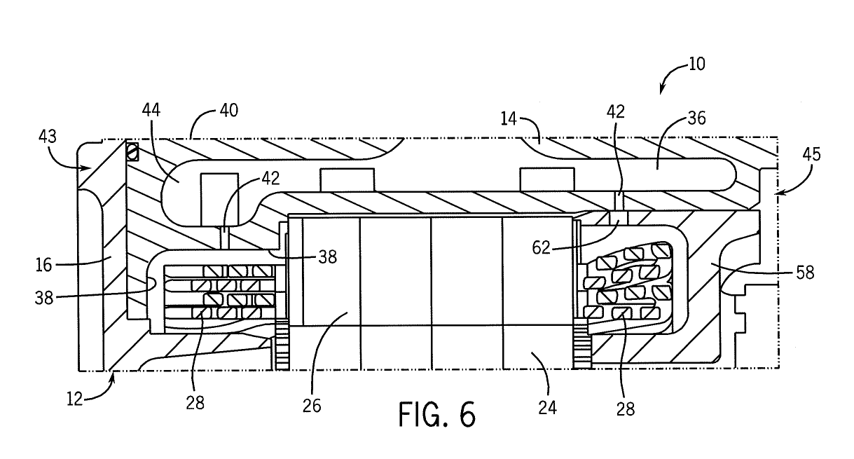

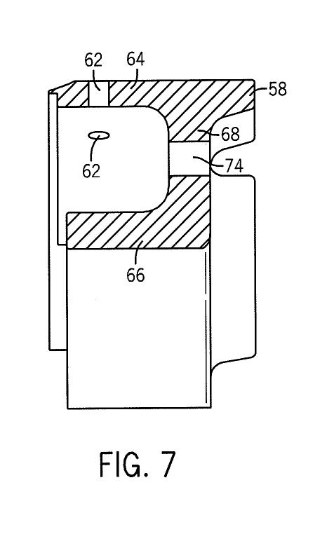

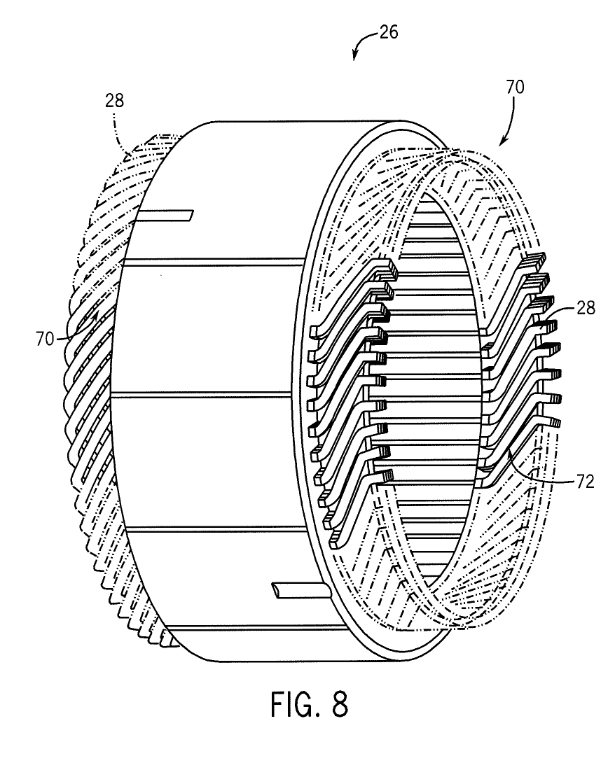

In some embodiments, the end turn member 58 can comprise a radially outer flange 64, a radially inner flange 66, and a central region 68. As shown in FIGS. 5-8, in some embodiments, the end turn member 58 can be formed so that the flanges 64, 66 axially extend into the machine cavity 22 from the central region 68 (e.g., the end turn member 58 can comprise a sideways-oriented “u” shape). In some embodiments, the end turn member 58 can be formed (e.g., cast, molded, machined, etc.) so that the radially outer flange 64 and the radially inner flange 66 can axially extend from the central region 68 so that at least a portion of the stator end turns 28 can be received within the end turn member 58. For example, in some embodiments, when the end turn member 58 is positioned substantially adjacent to the stator assembly 26, the radially outer flange 64 can be substantially adjacent to an outer diameter 70 of the stator end turns 28. Moreover, in some embodiments, the stator end turns can comprise an inner diameter 72. In some embodiments, the radially inner flange 66 can be substantially adjacent to the inner diameter 72 of the stator end turns, as shown in FIGS. 5-8. Accordingly, in some embodiments, the central region 68 can be substantially adjacent to an axially outermost portion of at least a portion of the stator end turns 28.

As a result of the substantially adjacent spatial relationship of the end turn member 58 and the stator end turns 28, in some embodiments, the end turn member 58 can at least partially enhance heat energy transfer. In some embodiments, the end turn member 58 can comprise a substantially thermally conductive material (e.g., aluminum), as previously mentioned. As a result, because portions of the end turn member 58 can be substantially adjacent to portions of the end turns 28 and in thermal communication with at least a portion of the end turns 28, the end turn member 58 can receive at least a portion of the heat energy produced by the end turns 28 during electric machine 20 operations. Moreover, as previously mentioned, in some embodiments, the end turn member 58 can be immediately adjacent to the inner wall 38 of the housing 12 (e.g., friction fit, interference fit, substantially integral, etc.), which can enhance heat energy transfer from the end turns 28 to the housing 12 via the end turn member 58 comprising thermally conductive materials.

Moreover, in some embodiments, the flanges 64, 66 can further aid in cooling. In some embodiments, the radially outer flange 64 can comprise the first member apertures 62 so that at least a portion of the coolant can flow through both the coolant apertures 42 and the first member apertures 62 and can contact the stator end turns 28. In some embodiments, before and/or after at least a portion of the coolant contacts the stator end turns 28, the end turn member 58 can enhance cooling by retaining at least a portion of the coolant adjacent to the end turns 28.

For example, in some embodiments, because the flanges 64, 66 and the central region 68 can be substantially adjacent to portions of the end turns 28, before and/or after the coolant contacts the end turns 28, the coolant can contact the end turn member 58. As a result, the coolant can at least partially accumulate immediately adjacent to the end turns 28 and/or bounce from the end turn member 58 to the end turns 28. In some embodiments, regardless of the mechanism, the end turn member 58 can at least partially enhance cooling because it can function to retain at least a portion of the coolant in close proximity to the stator end turns 28 so that more heat energy can be conducted to the coolant.

Furthermore, in some embodiments, the end turn member 58 can conduct at least a portion of the heat energy received from the stator end turns 28 to the housing 12. For example, because at least a portion of the coolant flows to the end turn member 58 after contacting the stator end turns 28 and receiving a portion of its heat energy, the coolant can conduct some of the heat energy to the end turn member 58. Moreover, in some embodiments, because the end turn member 58 can be integral with and/or contact the housing 12, the end turn member 58 can transfer at least a portion of the heat energy to the housing 12, which can transfer the heat energy to the surrounding environment via convection. Additionally, in some embodiments, the housing 12 and/or the end turn member 58 can conduct at least a portion of the heat energy into the coolant circulating through the coolant jacket 36, which can at least partially enhance module 10 cooling.

Moreover, in some embodiments, the end turn member 58 can function to enhance operations of the module 10. In some embodiments, the end turn member 58 can comprise different geometries that can be relevant to module 10 operations and cooling. For example, in some embodiments, the end turn member 58 can comprise a variety of annuli, additional apertures, slots, other geometries, or combinations thereof to aid in operations. As a result, in some embodiments, some of these geometries can at least partially serve to enhance cooling by further enhancing coolant accumulation substantially adjacent to the end turns 28.

Additionally, in some embodiments, the end turn member 58 can ease manufacturing burdens. For example, in some embodiments, a module 10 may require some of the previously mentioned geometries and/or configurations for operations (e.g., extra space near the end turns 28 or other space concerns). In some embodiments, by integrating these features within the housing 12, extra costs can be incurred in order to change the housing 12 manufacturing process. By integrating some of these features within the end turn member 58, housing 12 manufacturing can remain substantially the same and the geometries can be substantially integrated with the end turn member 58. By way of example only, in some embodiments, in order to accommodate some special features of the electric machine 20 (e.g., special end turn portions, electrical connection points, etc.), the end turn member 58 can comprise at least some of the previously mentioned geometries to enable positioning of the electric machine 20 within the housing 12. Accordingly, costs and manufacturing complexity can be minimized because simple machining can be performed on the housing 12 and more complex machining can be performed of the end turn member 58.

According to some embodiments of the invention, the end turn member 58 can enhance cooling in multiple module 10 configurations. For example, in some embodiments, the coolant jacket 36 can comprise a substantially sealed configuration. As a result, coolant can circulate through the jacket 36, but does not enter the machine cavity 22 via the apertures 42. Accordingly, coolant does not contact the stator end turns 28, which, in some embodiments, can impact module 10 cooling.

In some embodiments, the end turn member 58 can at least partially aid in cooling the stator end turns 28 where the coolant jacket 36 comprises a substantially sealed configuration. For example, in some embodiments, the end turn member 58 can comprise a substantially non-conductive material (e.g., aluminum) so that the flanges 64, 66 and the central region 68 can be substantially adjacent to portions of the end turns 28, as previously mentioned. As a result, in some embodiments, at least a portion of the heat energy produced by the stator end turns 28 can be transferred to the end turn member 58 via convection. Moreover, in some embodiments, because the end turn member 58 can be integral with and/or contact the housing 12, the end turn member 58 can transfer at least a portion of the heat energy to the housing 12, which can transfer the heat energy to the surrounding environment via convection or to the coolant circulating through the coolant jacket 36.

In some embodiments, the stator end turns 28 can comprise a substantially potted configuration. In some embodiments, at least a portion of the stator end turns 28 can be coated, encased, or otherwise covered in a potting composition that can at least partially enhance thermal conductivity from the end turns 28. In some embodiments, the potting composition can comprise a resin. For example, in some embodiments, the potting composition can comprise an epoxy resin, although, the potting composition can comprise other resins. In some embodiments, resins can provide a generally appropriate dielectric constant, thermal conductivity, thermal expansion, chemical resistance, etc. for use in applications involving module 10 operational temperatures and current flow. For example, in some embodiments, the potting composition can be converted to a substantially liquid state (e.g., via heating) and gravity fed or injected over and/or around the end turns 28. In some embodiments, the end turns 28 can be placed in a mold prior to the gravity feed or injection process so that the potting composition can cover at least a portion of the stator end turns 28 and can comprise a shape at least partially corresponding the shape of the mold. As a result, the potted stator end turns 28 can comprise a shape and/or configuration desired by the manufacturer and/or end user. In some embodiments, the potting composition can comprise a two-part mixture so that a first portion of the potting composition an a second portion of the potting composition can be mixed to activate the potting composition prior to application to the end turns 28.

In some embodiments, the end turn member 58 can aid in cooling the stator end turns 28 comprising a potted configuration. For example, in some embodiments, the potted end turns 28 can be configured and arranged so that, after solidifying, the potting composition can be immediately adjacent to and/or contact the flanges 64, 66 and the central region 68. As a result, in some embodiments, the potted stator end turns 28 can conduct at least a portion of the heat energy produced by the stator end turns 28 to the housing 12 via the end turn member 58. For example, as previously mentioned, in some embodiments, the potting composition can be generally thermally conductive so that at least a portion of the heat energy produced by the stator end turns 28 can be substantially conducted from the end turns 28 to the end turn member 58 via the potting composition.

In some embodiments, the end turn member 58 can be used in potting at least a portion of the stator end turns 28. In some embodiments, the end turn member 58 can function as the mold that can be used to form the potted stator end turns 28. For example, in some embodiments, the stator assembly 26 can be positioned with respect to the end turn member 46 so that at least a portion of the stator end turns 28 are positioned within the end turn member 46 (e.g., substantially adjacent to the flanges 64, 66 and the central region 68), as previously mentioned. In some embodiments, after positioning the end turn member 58 with respect to the stator end turns 28, the potting composition can be gravity fed and/or injected around and through at least a portion of the stator end turns 28 so that the stator end turns 28 can be substantially enclosed by the potting composition after curing, as previously mentioned. As a result, in some embodiments, the end turn member 58 can be in contact with the stator end turns 28 via the potting composition so that heat energy can be conducted after the potting composition cures. The end turn member 58 can be used in the potting process before, during, and/or after assembly of the module 10.

In some embodiments, the end turn member 58 can comprise at least one second member aperture 74. In some embodiments, the end turn member 58 can comprise a plurality of second member apertures 74, as shown in FIG. 5. In some embodiments, the second member apertures 74 can be disposed in a generally axial direction through a portion of the central region 68, as illustrated in FIGS. 5-7. In some embodiments, the second member apertures 74 can be, at least partially, circumferentially arranged with respect to the end turn member 58. For example, in some embodiments, the second member apertures 74 can be arranged in regular circumferential patterns (e.g., an aperture 74 positioned every 30 degrees) or irregular circumferential patterns. Moreover, in some embodiments, the inner wall 38 of the housing 12 can comprise at least some second member apertures 74 so that at least some embodiments functioning without the end turn member 58 can operate as described below. For example, in some embodiments, the inner wall substantially adjacent to the first axial side 43 can comprise at least one second member aperture 74.

In some embodiments, at least a portion of the second member apertures 74 can function as expansion joints. In some embodiments comprising at least some potted stator end turns 28, the second member apertures 74 can function to account for potting composition expansion. For example, during operation of the electric machine 20, the production of heat energy by at least a portion of the stator end turns 28 can cause thermal expansion of the potting material. As a result of the thermal expansion of the potting composition, in some embodiments, a force and/or pressure can be applied to at least a portion of the stator end turns 28, the flanges 64, 66 and/or the central region 68, which can lead to damage to the end turn member 58 and/or the stator end turns 28.

In some embodiments, the second member apertures 74 can function to at least partially relieve the pressure associated with the thermal expansion of the potting composition. For example, in some embodiments, when the potting composition expands, at least a portion of the potting composition can expand into and/or through at least some of the second member apertures 74. As a result, in some embodiments, the force and/or pressure exerted upon at least some of the stator end turns 28 can be at least partially relieved by the second member apertures 74, which can at least partially reduce the risk of damage to the stator end turns 28 and/or end turn member 46 stemming from potting composition thermal expansion.

In some embodiments, the second member apertures 74 can be used in the potting process. In some embodiments, at least some of the second member apertures 74 can function as a potting composition inlet during the potting process. For example, in some embodiments, the potting composition can be gravity fed and/or injected around at least some portions of the stator end turns 28, as previously mentioned. In some embodiments, however, another volume of potting composition can be fed around portions of the stator end turns 28 via at least some of the second member apertures 74.

Moreover, in some embodiments, during the potting process, at least some of the second member apertures 74 can be substantially sealed (e.g. “capped-off”) with a sealing structure (not shown) so that the potting composition does not flow through the second member apertures 74 during the potting process. Then, once the potting composition has substantially solidified (e.g., cured), the sealing structure can be removed and the second member apertures 74 can function as expansion joints during module 10 operations, as previously mentioned. Furthermore, in some embodiments, the end turn member 58 can substantially lack at least a portion of the second member apertures 74 prior to use in the potting process. After the end turns 28 are potted in the potting composition, at least a portion of the second member apertures 74 can be formed (e.g., machined, drilled, punched, stamped, etc.) for use as previously mentioned.

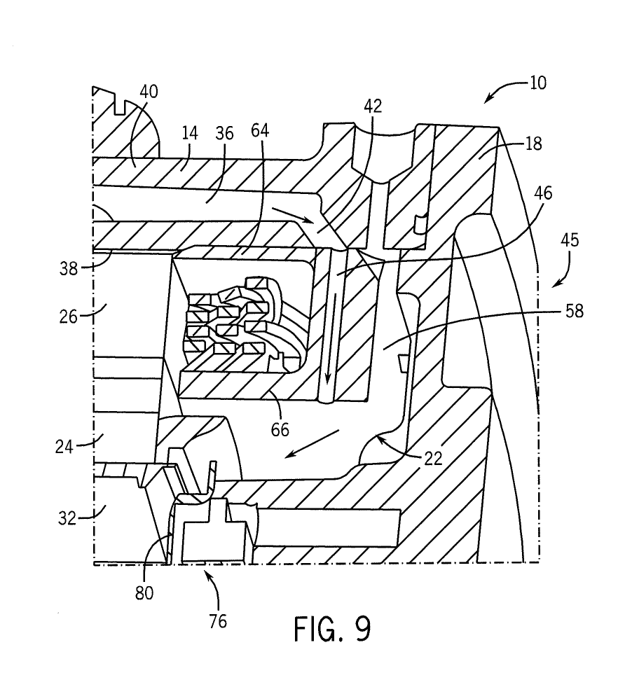

In some embodiments, the end turn member 58 can comprise at least one coolant passage 46. In some embodiments, the end turn member 58 can comprise a plurality of coolant passages 46. In some embodiments, the end turn member 58 can comprise a plurality of coolant passages 46 radially oriented through a portion of the central region 68. Moreover, in some embodiments, as shown in FIG. 9, at least some of the coolant passages 46 can extend a radial length of some portions of the central region 68 and/or the end turn member 58. Additionally, in some embodiments, the coolant passages 46 can be positioned through other portions of the end turn member 58. In some embodiments, at least some of the coolant passages 46 can be at least partially circumferentially arranged through portions of the end turn member 58. In some embodiments, the coolant passages 46 can be circumferentially arranged in a substantially regular or irregular pattern around at least a portion of a circumference of the end turn member 58. As a result, at least a portion of the coolant passages 46 can be positioned substantially adjacent to the first axial end 43 (e.g., between the recesses 47 as previously mentioned) and the second axial end 45 through portions of the end turn member 58.

In some embodiments, at least a portion of the coolant apertures 42 can fluidly connect the coolant jacket 36 with the coolant passages 46 of the end turn member 58. In some embodiments, as shown in FIG. 9, at least some of the coolant apertures 42 can be configured and arranged to direct at least a portion of the coolant flowing through the coolant jacket 36 into the coolant passages 46 of the end turn member 58. For example, in some embodiments, at least a portion of the coolant apertures 42 can comprise a substantially angled configuration, as shown in FIG. 9, so that coolant can flow from the coolant jacket 36 to at least some of the coolant passages 46 of the end turn member 58.

In some embodiments, the outlet 51 of the coolant passage 46 of the end turn member 58 can fluidly connect at least a portion of the coolant passages 46 with the machine cavity 22. In some embodiments, at least a portion of the inner wall 38 can be configured and arranged to guide at least a portion of the coolant in a generally axially and radially inward direction. For example, as shown by the arrows in FIG. 9, in some embodiments, at least a portion of the coolant can enter the machine cavity 22 from the coolant passages 46 so that the coolant can be used in cooling applications, as described in further detail below.

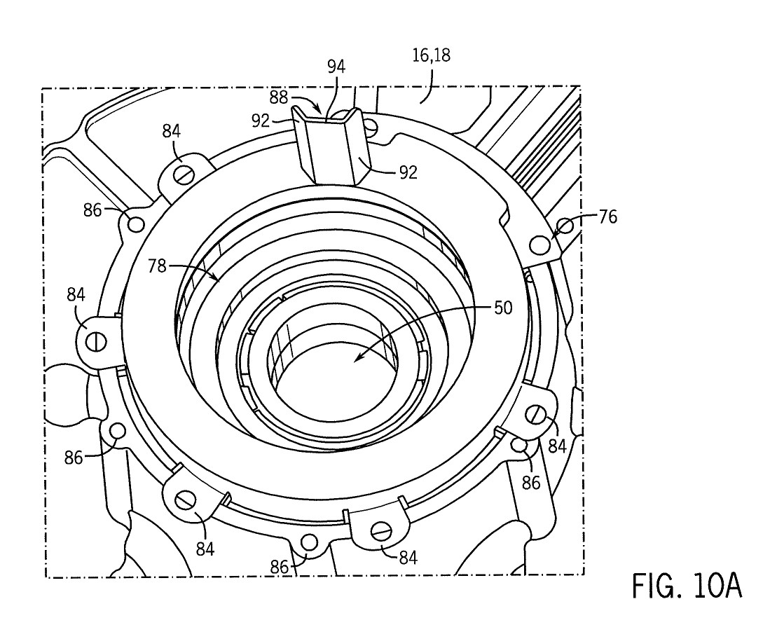

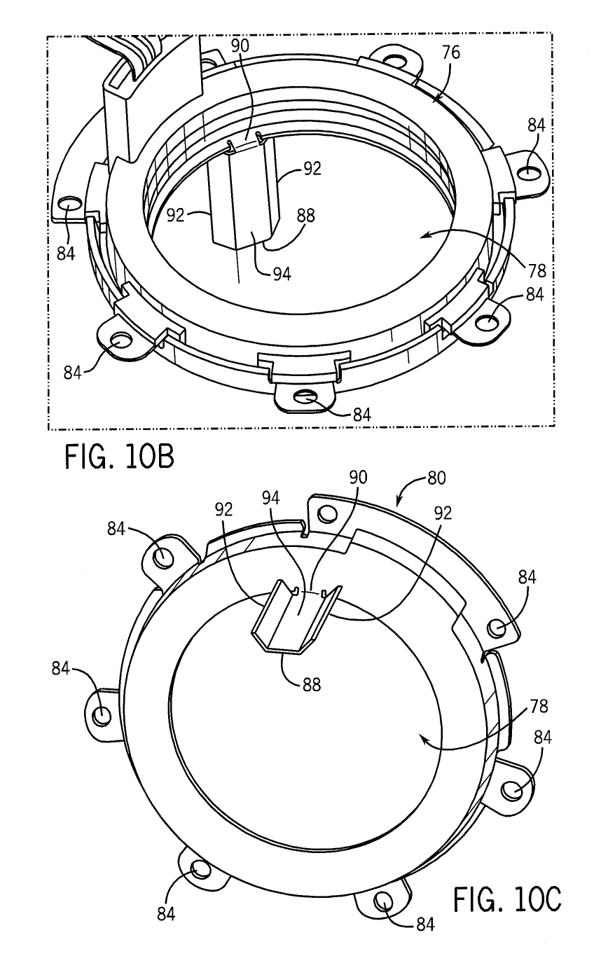

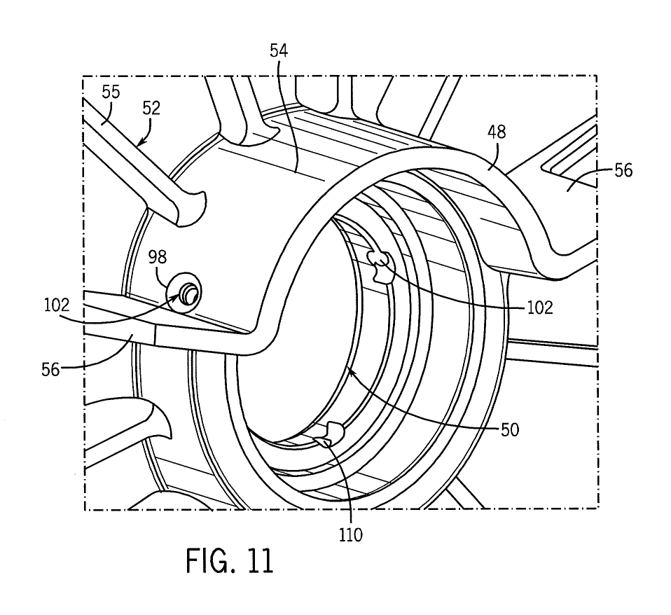

In some embodiments, the module 10 can comprise a sensor assembly 76, as shown in FIGS. 10A-10C. In some embodiments, the sensor assembly 76 can be coupled to at least a portion of the housing 12 so that it is in mechanical and/or electrical communication with the rotor assembly 24 and/or the shaft 34. In some embodiments, the sensor assembly 76 can comprise a resolver assembly, although, in other embodiments, the sensor assembly 76 can comprise other sensors. For example, in some embodiments, the sensor assembly 76 can comprise a bearing assembly, a bearing assembly shield, a Hall Effect sensor, a temperature sensor, a speed sensor, a direction sensor, a position sensor, and other elements that can function to sense or detect elements associated with the module 10. In some embodiments, the mechanical communication between the sensor assembly 76 and the rotor assembly 24 and/or the shaft 34 can be used to measure rotation of the rotor assembly 24 and/or the shaft 34 during operation of the electric machine 20. Moreover, in some embodiments, the sensor assembly 76 can be electrically connected to a control unit (not shown) so that any sensed data can be inputted into the control unit for use in determining operational parameters of the module 10. Furthermore, in some embodiments, the sensor assembly 76 can comprise a sensor aperture 78 that can be configured and arranged to receive at least a portion of the rotor assembly 24 and/or the shaft 34 for measuring rotation.

In some embodiments, the sensor assembly 76 can comprise a sensor cover 80, as shown in FIG. 10C. In some embodiments, the sensor cover 80 can be coupled to at least a portion of the inner wall 38 of the housing 12 via fasteners 82. In some embodiments, the sensor cover 80 can at least partially protect the sensor assembly 76 from any potentially harmful elements within the module 10 (e.g., errant coolant splashes, debris, electromagnetic interference produced by current flowing through the stator assembly 26, etc.). Accordingly, the sensor cover 80 can function as a mechanical, electrical, and/or electromagnetic barrier to protect the sensor assembly 76. For example, as shown in FIGS. 10A and 10B, the sensor cover 80 can comprise a plurality of apertures 84 and at least one of the end caps 16, 18 can comprise similarly configured apertures 86 so that the fasteners 82 can couple together at least these elements.

In some embodiments, the sensor cover 80 can comprise a second guide 88. As shown in FIGS. 2 and 10A-10C, in some embodiments, the second guide 88 can be coupled to the sensor cover 80 using any and/or all of the previously mentioned coupling methods. Moreover, in some embodiments, the second guide 88 can be substantially integral with the sensor cover 80. In some embodiments, as shown in FIGS. 2 and 10A-10C, the second guide 88 can axially extend into the machine cavity 22 from the sensor cover 80. For example, as shown in FIG. 2, in some embodiments, the second guide 88 can axially extend toward the rotor assembly 24 (e.g., the rotor hub 32). Additionally, in some embodiments, second guide 88 can comprise a coupling flange 90 positioned between the sensor cover 80 and the second guide 88, as shown in FIG. 10B. In some embodiments, the coupling flange 90 can enable positioning of the second guide 88 for use in coolant distribution within the machine cavity 22.

In some embodiments, the second guide 88 can be configured and arranged to guide at least a portion of the coolant from the machine cavity 22 toward the rotor assembly 24. In some embodiments, at least a portion of the coolant can exit at least some of the coolant passages 46 of the end turn member 58 and can enter the machine cavity 22. Once in the machine cavity 22, at least some of the coolant can flow radially inward toward the second guide 88. For example, in some embodiments, the second guide 88 can comprise angled sections 92 and a substantially linear section 94. In some embodiments, as a portion of the coolant flows radially inward toward the second guide 88, the angled sections 92 can function to catch at least a portion of the coolant and direct the coolant toward the linear section 94. Although depicted as substantially linear (e.g., substantially parallel to a horizontal axis of the shaft 34), the linear section 94 can be angled, bent, curved, or otherwise configured to guide at least a portion of the coolant toward a desired location (e.g., the rotor assembly 24).

In some embodiments, the second guide 88 and the linear section 94 can direct at least a portion of the coolant toward the rotor assembly 24. Accordingly, in some embodiments, at least a portion of the coolant can contact the rotor assembly 24 (e.g. the rotor hub 32 and other rotor assembly 24 elements) to receive at least a portion of the heat energy produced, which can lead to module 10 cooling. Moreover, in some embodiments, due to the movement of the rotor assembly 24, at least a portion of the coolant can be slung in a generally radially outward direction. As a result, in some embodiments, at least a portion of the radially slung coolant can contact the inner diameter 72 of the stator end turns 28 and other portions of the stator assembly 24 to cool at least those elements.

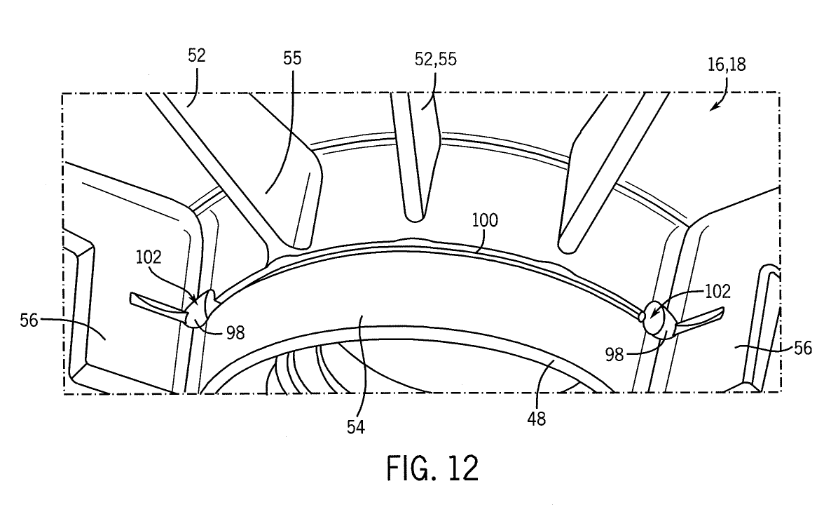

As shown in FIGS. 4, 11 and 12, in some embodiments, the module 10 can comprise other cooling and/or lubrication configurations. As shown in FIGS. 11 and 12, in some embodiments, the first guide 48 can be configured and arranged to guide at least a portion of the coolant radially inward toward other elements of the module 10. In some embodiments, the module 10 can comprise at least one coolant seal 96 positioned substantially immediately adjacent to at least one of the axial ends 43, 45 and substantially adjacent to the shaft apertures 50 of the end caps 16, 18. In some embodiments, the module 10 can comprise a coolant seal 96 at both axial ends 43, 45 to substantially seal the machine cavity 22 and other parts of the module 10 from the outside environment. For example, in some embodiments, the coolant seals 96 can function to prevent any material amounts of coolant from exiting the machine cavity 22 via the shaft aperture 50.

In some embodiments, the first guide 48 can comprise at least one guide aperture 98. In some embodiments, the first guide 48 can comprise more than one guide aperture 98, as shown in FIGS. 4, 11, and 12. In some embodiments, the first guide 48 can comprise at least one guide aperture 98 position substantially adjacent to at least one of the baffles 56. For example, in some embodiments, as shown in FIG. 12, in some embodiments, the first guide 48 can comprise two apertures 98 substantially adjacent to the baffles 56 disposed at the lateral edges of the first guide 48. In other embodiments, the first guide 48 can comprise at least one guide aperture 98 disposed anywhere along the surface of the first guide 48. Although described and depicted as disposed on the first guide 48, in some embodiments, the second guide 88 can comprise guide apertures 98, in addition to or in lieu of the first guide 48.

In some embodiments, the housing 12 can comprise at least one guide channel 100. For example, as shown in FIG. 12. in some embodiments, the guide channel 100 can be disposed on a radially outward surface of the first guide 48. In some embodiments, the channel 100 can extend through a width of the first guide 48, although, in other embodiments, the channel 100 can extend a lesser distance than the width of the first guide 48. In some embodiments, the channel 100 can be integral with the housing 12 and/or the first guide 48 (e.g., the housing 12 and/or the first guide 48 can be formed with the channel 100). In some embodiments, the channel 100 can be formed (e.g., machined) into the guide 48 and/or housing 12 after formation of the guide 48 and/or housing 12. Although described and depicted as disposed on the first guide 48, in some embodiments, the second guide 88 can comprise a guide channel 100, in addition to or in lieu of the first guide 48.

In some embodiments, the guide channel 100 can direct at least a portion of the coolant. In some embodiments, the guide channel 100 can direct at least a portion of the coolant flowing radially inward from the coolant passages 46. In some embodiments, as shown in FIG. 12, the channel 100 can be at least partially circumferentially arranged with respect to the first guide 48. By way of example only, in some embodiments, as shown in FIG. 12, the channel 100 can extend from one guide aperture 98 to another guide aperture 98 so that as coolant flows radially inward, at least a portion of the coolant can enter the channel 100 and the channel 100 can direct the coolant toward the apertures 98.

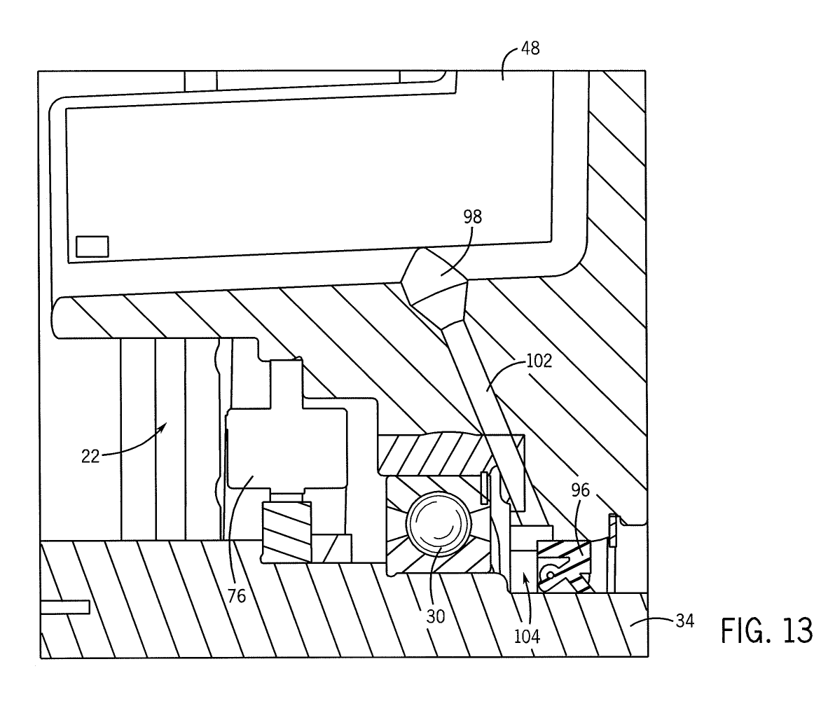

As shown in FIG. 13, in some embodiments, the module 10 can comprise at least one guide passage 102. For example, in some embodiments, the housing 12 can comprise the guide passage 102. Moreover, in some embodiments, the guide passage 102 can extend from at least one of the guide apertures 98. In some embodiments, the housing 12 and/or the first guide 48 can comprise at least one guide passage 102 extending from each guide aperture 98. In some embodiments, the passages 102 can extend in a generally radial and axial direction. As shown in FIG. 13, in some embodiments, the passages 102 can be positioned within the housing 12 and/or first guide 48 so that the passages 102 are substantially angled. For example, in some embodiments, at least a portion of the passages 102 can be disposed so that at least a portion of the coolant can flow toward the shaft aperture 50. In some embodiments, at least a portion of the guide passages 102 can be substantially integral with the housing 12 (e.g., the housing 12 can be formed with the passages 102 in place). In some embodiments, at least a portion of the guide passages 102 can be formed (e.g., machined) in the housing 12 after manufacture of the housing 12.

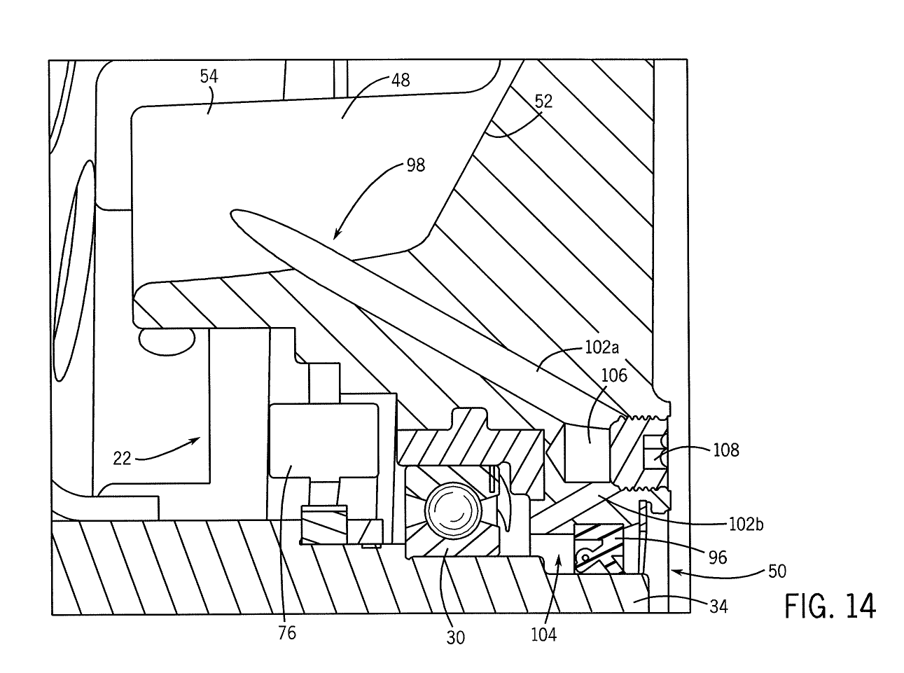

In some embodiments, the module 10 can comprise at least one seal cavity 104. As shown in FIGS. 13 and 14, in some embodiments, the seal cavity 104 can be at least partially defined by portions of the bearings 30, the coolant seal 96, the shaft 34, and the housing 12 (e.g., at least one of the end caps 16, 18 or the canister and or the canister end cap). In some embodiments, the seal cavity 104 can comprise a recess within the module 10 that can substantially circumscribe at least a portion of the shaft 34 immediately adjacent to the coolant seal 96 and the bearings 30. Furthermore, in some embodiments, the module 10 can comprise at least one seal cavity 104 per coolant seal 96 (e.g., one seal cavity 104 on each axial end of the module 10 disposed immediately adjacent to each coolant seal 96).

In some embodiments, the guide passage 102 can be configured and arranged to guide at least a portion of the coolant toward at least one seal cavity 104. In some embodiments including more than one seal cavity 104, more than one guide passage 102 can be configured and arranged to guide at least a portion of the coolant toward the seal cavities 104. For example, as shown in FIGS. 13 and 14, in some embodiments, the guide passage 102 can be disposed through portions of the housing 12 and/or the first guide 48 so that at least a portion of the coolant can reach the seal cavity 104.

In some embodiments, once the coolant reaches at least one of the seal cavities 104, at least a portion of the coolant can contact some of the elements defining the seal cavities 104. In some embodiments, upon reaching the seal cavity 104 via the passage 102, the coolant can contact portions of the seal 96, the shaft 34, the housing 12, and the bearings 30. In some embodiments, the contact of the coolant with at least some of these elements can provide lubrication and/or cooling benefits. For example, in some embodiments, at least a portion of the coolant can contact the seal 96 to receive at least a portion of the heat energy produced by the seal 96. Moreover, in some embodiments, at least a portion of the coolant can provide lubrication benefits to the seal 96 and/or the bearings 30. As a result, in some embodiments, the coolant flowing into the seal cavity 104 can at least partially enhance module 10 operations because of the cooling and lubrication benefits.

In some embodiments, guide passages 102 can comprise multiple configurations. As shown in FIG. 14, in some embodiments, at least a portion of the guide passages 102 can comprise a first guide passage 102a fluidly connected to a second guide passage 102b. In some embodiments, the first guide passage 102a can fluidly connect to the second guide passage 102b via a guide reservoir 106. In some embodiments, the guide reservoir 106 can be substantially sealed via a plug 108. In some embodiments, the combination of the first and second guide passages 102a, 102b can enable positioning of at least a portion of the guide passages 102 within the housing 12. For example, in some embodiments comprising a canister, positioning of the guide passages 102 can be complicated by the configuration of the canister (e.g., axially extending walls can complicate the machining of the passages 102). By way of example only, in some embodiments, the guide passages 102 can be machined into the housing 12 to accomplish providing a passage for at least a portion of the coolant to reach at least one of the seal cavities 104. For example, in some embodiments, the first guide passage 102a, the guide reservoir 106, and the second guide passage 102b can be disposed in the housing 12 so that at least a portion of the coolant entering the guide apertures 98 can reach the seal cavities 104. Moreover, in some embodiments, because of the machining process, the plug 108 can be at least partially positioned within the guide reservoir 106 to substantially seal the reservoir and to prevent material amounts of coolant from exiting the reservoir 106 other than via the second guide passage 102b.

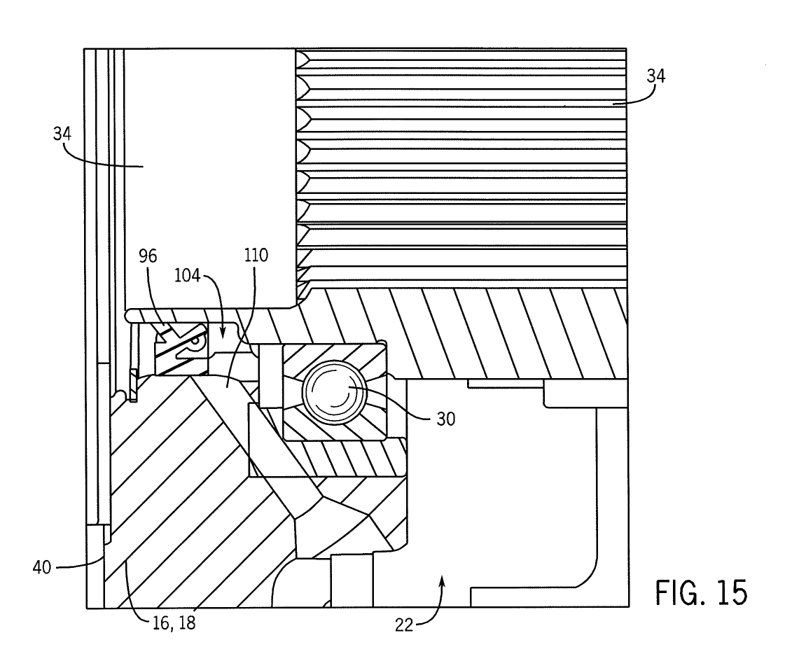

In some embodiments, at least a portion of the coolant can exit the seal cavity 104 after contacting at least a portion of the elements defining the seal cavity 104. In some embodiments, the housing 12 can comprise an outlet channel 110. In some embodiments, the housing 12 can comprise more than one outlet channel 110. In some embodiments, the outlet channel 110 can substantially extend through at least a portion of the housing 12 can be in fluid communication with the seal cavity 104. For example, in some embodiments, the outlet channel 110 can be disposed through a portion of the housing 12 so that it is generally positioned at a generally bottom region of the housing 12 portion defining the shaft aperture 50 (e.g., a generally “6 o'clock” position). As a result, in some embodiments, at least a portion of the coolant can flow from the guide passages 102 and/or 102a and 102b, can enter the seal cavity 104 and contact at least some of the elements defining the seal cavity 104, and can exit the seal cavity 104 via the outlet channel 110. In some embodiments, the previously mentioned configuration can at least partially enable coolant flow through the seal cavity 104 to enhance cooling and/or lubrication of some module 10 elements. In some embodiments, as shown in FIG. 15, the outlet channel 110 can be substantially angled so that as coolant enters the outlet channel 110, at least a portion of the coolant can be guided substantially radially outward and axially inward.

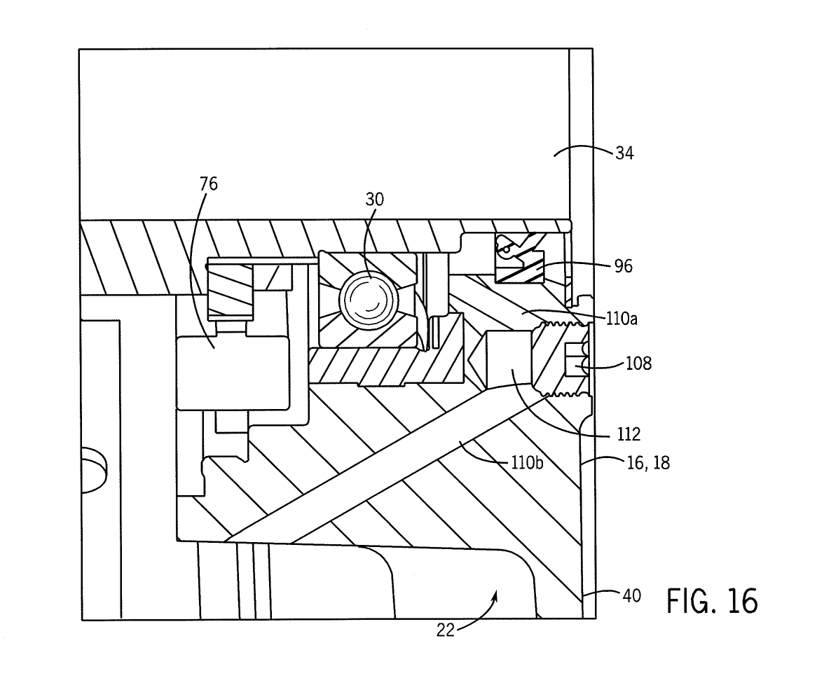

Similar to the guide passage 102, in some embodiments, the outlet channel 110 can comprise different configurations. As shown in FIG. 16, in some embodiments, the outlet channel 110 can comprise a first outlet channel 110a fluidly connected to a second outlet channel 110b. In some embodiments, the first outlet channel 110a can fluidly connect to the second outlet channel 110b via an outlet reservoir 112. In some embodiments, the outlet reservoir 112 can be substantially sealed via the same or a different plug 108. In some embodiments, the combination of the first and second outlet channels 110a, 110b can enable positioning of at least a portion of the outlet channels 110 within the housing 12. For example, in some embodiments comprising a canister, positioning of the outlet channels 110 can be complicated by the configuration of the canister (e.g., axially extending walls can complicate the machining of the outlet channels 110). By way of example only, in some embodiments, at least a portion of the outlet channels 110 can be machined into the housing 12 to accomplish providing a passage for at least a portion of the coolant to flow from at least some of the seal cavities 104. For example, in some embodiments, the first outlet channel 110a, the outlet reservoir 112, and the second outlet channel 110b can be disposed in the housing 12 so that at least a portion of the coolant can exit at least some of the seal cavities 104. Moreover, in some embodiments, because of the machining process, the plug 108 can be at least partially positioned within the outlet reservoir 112 to substantially seal the reservoir 112 and to prevent material amounts of coolant from exiting the reservoir 112 other than via the second outlet channel 110b.

In some embodiments, the outlet channel 110 (or 110a and 110b) can fluidly connect at least a portion of the seal cavities 104 with the machine cavity 22. For example, in some embodiments, at least a portion of the coolant that enters the outlet channel 110 can enter the machine cavity 22 and flow through portions of the machine cavity 22 and contact elements of the module 10. As a result, in some embodiments, at least a portion of the module 10 elements contacted by portions of the coolant can conduct at least a portion of the heat energy produced to the coolant, which can at least partially enhance cooling.

Moreover, in some embodiments, after entering the machine cavity 22, at least a portion of the coolant can flow toward a bottom of the module 10 via gravity. In some embodiments, the module 10 can comprise a conventional drain system (not shown) generally positioned at the bottom of the module 10 so that at least a portion of the coolant can flow from the machine cavity 22 into the drain system. Although, in some embodiments, at least a portion of the coolant can directly enter the drain system from the coolant jacket 36 and/or the guides 48, 88. In some embodiments, the drain system can fluidly connect the machine cavity 22 to a conventional heat exchange element (e.g., a radiator, a heat exchanger, etc.) that can be integral with, adjacent to, and/or remote from the module 10 (not shown). In some embodiments, at least a portion of the coolant can circulate through the heat exchange element where at least a portion of the heat energy can be removed and the coolant can be re-circulated for further cooling.

Relative to some conventional electric machine modules, some embodiments of the invention can offer enhanced electric machine 20 cooling. For example, at least some conventional electric machines can include a coolant distribution system where coolant flows through the shaft and radially outward through some machine elements, such as a rotor hub. In order to assemble a coolant distribution system like those of some conventional machines, specially configured shafts, seals, fittings, interfaces, and other elements of the module can be necessary, which can add costs and complexity to the assembly process. Additionally, some of the shafts used for this type of conventional cooling configuration can require internal splines to couple the shaft to the rotor assembly, which can further add complexity. Some embodiments of the invention can obviate at least some of these disadvantages. For example, in some embodiments, special, complex, and/or expensive shafts, seals, fittings, interfaces, and other elements can be unnecessary because the coolant is introduced to the rotor assembly 24 via the coolant jacket 36. Moreover, in some embodiments, either internal or external splines can be used in coupling the machine 20 to the shaft 34. In addition, some embodiments of the invention can enable module 10 usage in some systems that do not permit coolant flow through the shaft. For example, some module 10 systems and applications can be constrained such that it is not permissible for coolant to flow through the shaft, which could limit module usage and cooling. However, in some embodiments of the invention, as previously mentioned, coolant need not flow through the shaft to coolant portions of the module 10.

Additionally, some embodiments of the invention can enable a greater volume of coolant comprising a lesser temperature to reach the rotor assembly 24 relative to some conventional electric machines. Some conventional electric machines, in order to reduce the complexity associated with complex and expensive special elements, as previously mentioned, can pass at least a portion of coolant circulating through a coolant jacket through coolant apertures and on to the stator end turns. Then, at least a portion of the coolant can flow radially inward and contact the rotor assembly, for cooling purposes. However, in some conventional machines, because the coolant has already passed over, through, and/or adjacent to the stator end turns, the coolant is already at an elevated temperature when it reaches the rotor assembly. Some embodiments of the invention can at least partially obviate this issue. For example, in some embodiments, at least a portion of the coolant can flow from the coolant jacket 36 to the machine cavity 22 via the coolant passages 46 so that at least some of the coolant reaching the machine cavity 22 has not yet directly contacted the stator end turns 28. As a result, in some embodiments, cooling of the rotor assembly 24 can be at least partially enhanced because at least some of the coolant reaching the rotor assembly 24 can be cooler compared to some conventional electric machines.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An electric machine module comprising:
a housing at least partially defining a machine cavity, the housing further including
a first axial end and a second axial end,
an inner wall and an outer wall,
a plurality of coolant passages defined by at least a portion of the housing, at least one of the plurality of coolant passages being positioned substantially adjacent to the first axial end and being in fluid communication with the machine cavity, and
a first guide positioned substantially adjacent to the first axial end and at least partially extending into the machine cavity;
a coolant jacket positioned substantially within the housing; and
an electric machine positioned substantially within the machine cavity and at least partially enclosed by the housing, the electric machine including a rotor assembly, the electric machine positioned within the machine cavity so that at least a portion of the rotor assembly is substantially adjacent to the first guide, and the first guide being configured and arranged to guide a coolant toward the rotor assembly.

2. The electric machine module of claim 1 and further comprising a sensor assembly coupled to the inner wall of the housing substantially adjacent to the second axial end.

3. The electric machine module of claim 2, wherein at least one of the plurality of coolant passages is positioned substantially adjacent to the second axial end and is in fluid communication with the machine cavity.

4. The electric machine module of claim 2, wherein the sensor assembly comprises a sensor cover including a second guide extending into the machine cavity, the second guide being positioned so that at least a portion of the rotor assembly is substantially adjacent to the second guide, and the second guide is configured and arranged to guide a coolant toward the rotor assembly.

5. The electric machine module of claim 1, wherein the first guide comprises at least one guide aperture and at least one guide passage, and wherein the at least one guide aperture fluidly connects the machine cavity and the at least one guide passage.

6. The electric machine module of claim 1, wherein the first guide comprises at least two guide apertures and a channel.

7. The electric machine module of claim 1 and further comprising a plurality of coolant apertures disposed through a portion of the inner wall, wherein at least a portion of the plurality of coolant apertures are substantially axially oriented and at least a portion of the plurality of coolant apertures are substantially radially oriented.

8. The electric machine module of claim 1 and further comprising an end turn member at least partially positioned within the machine cavity, wherein the end turn member includes
a radially inward flange and a radially outward flange axially extending from a central region, and
at least one coolant passage positioned through a portion of the central region.

9. The electric machine module of claim 8 and further comprising a plurality of coolant apertures disposed through portions of the inner wall, and at least one of the plurality of coolant apertures configured and arranged to fluidly connect the coolant jacket and the at least one coolant passage positioned through at least a portion of the central region.

10. The electric machine module of claim 9 and further comprising at least one member aperture axially-oriented through at least a portion of the central region.

11. The electric machine module of claim 9 and further comprising at least one member aperture radially-oriented through at least a portion of the radially outward flange.

12. An electric machine module comprising:
a housing at least partially defining a machine cavity, the housing further including
a first axial end and a second axial end, and
a plurality of coolant passages defined by at least a portion of the housing, at least a portion of the plurality of coolant passages being positioned substantially adjacent to the first axial end and the second axial end and being in fluid communication with the machine cavity;
a sensor assembly coupled to a portion of the housing, the sensor assembly including a guide positioned substantially adjacent to the second axial end and at least partially extending into the machine cavity; and
the guide comprising at least one guide aperture and at least one guide passage so that the at least one guide aperture fluidly connects the machine cavity and the at least one guide passage.

13. The electric machine module of claim 12, wherein the housing comprises an inner wall, an outer wall, and a coolant jacket positioned between a portion of the inner wall and a portion of the outer wall.

14. The electric machine module of claim 13 and further comprising a plurality of coolant apertures disposed through at least a portion of the inner wall, and at least a portion of the coolant apertures are configured and arranged to fluidly connect the coolant jacket and at least a portion of the plurality of coolant passages.

15. The electric machine module of claim 12 and further comprising an electric machine positioned within the machine cavity and at least partially enclosed by the housing, the electric machine including a stator assembly substantially circumscribing at least a portion of a rotor assembly.

16. The electric machine module of claim 15, wherein the guide is positioned substantially adjacent to the rotor assembly and is configured and arranged to guide at least a portion of a coolant from the machine cavity toward the rotor assembly.

17. The electric machine module of claim 12 and further comprising an end turn member at least partially positioned within the machine cavity, wherein the end turn member includes
a radially inward flange and a radially outward flange axially extending from a central region, and
at least one coolant passage positioned through at least a portion of the central region.

18. The electric machine module of claim 17 and further comprising a plurality of member apertures defined through at least a portion of the radially outward flange.

19. A method of manufacturing an electric machine module, the method comprising:
providing a housing including an inner wall, an outer wall, a first axial end, and a second axial end;
positioning a coolant jacket within the housing between at least a portion of the inner wall and the outer wall, the coolant jacket positioned substantially between the first axial end and the second axial end;
disposing a plurality of coolant passages through at least a portion of the housing so that a portion of the plurality of coolant passages is substantially adjacent to the first axial end and another portion of the plurality of coolant passages is substantially adjacent to the second axial end;
positioning a guide along the inner wall substantially adjacent to the first axial end; and
disposing at least one guide aperture and guide passage through at least a portion of the guide.

20. The method of claim 19 and providing a sensor assembly including a second guide and positioning the sensor assembly substantially adjacent to the second axial end.
